(19) United States
(12) Patent Application Publication
(10) Pub. No.: US 2019/0308298 A1
(43) Pub. Date: Oct. 10, 2019

(54) ARRANGEMENT AND PROCESS FOR TREATING A SURFACE

(71) Applicant: L'Air Liquide, Société Anonyme Pour I'Etude et I'Exploitation des Procédés Georges Claude, Paris (FR)

(72) Inventor: Cerkez KAYA, Krefeld (DE)

(21) Appl. No.: 16/467,293

(22) PCT Filed: Dec. 6, 2017
(86) PCT No.: PCT/EP2017/081730

§ 371 Date: Jun. 6, 2019

(30) Foreign Application Priority Data
Dec. 8, 2016 (DE) 10 2016 123 813.9

(51) Int. Cl. B24C 5/04; B24C 1/00; B05B 7/14; B05B 7/04

(52) U.S. Cl. CPC B24C 5/04; B05B 7/0483; B05B 7/1481; B24C 1/003

(57) ABSTRACT

An apparatus and method for treating a surface with a jet having a multiplicity of particles, comprising an outer nozzle and at least two inner nozzle units, which are enclosed by the outer nozzle and are designed to introduce in each case a stream of propellant gas mixed with a multiplicity of particles into the outer nozzle, the outer nozzle being designed to combine the streams of propellant gas of the inner nozzle units to form an overall stream of propellant gas.

### CROSS REFERENCE TO RELATED APPLICATIONS

This application is a 371 of International PCT Application PCT/EP2017/081730, filed Dec. 6, 2017, which claims priority to German Patent Application No. 10 2016 123 813.9, filed Dec. 8, 2016, the entire contents of which are incorporated herein by reference.

### BACKGROUND

The invention relates to an arrangement and a process for treating a surface, in particular with a jet comprising a multiplicity of particles.

In many situations, a surface has to undergo mechanical cleaning. It may for instance be necessary in the production of wires for example to clean the finished product to ensure product quality. In solutions known for doing this, a wide variety of chemical and/or mechanical cleaning processes are used. The following come into consideration for example: grinding, brushing, ultrasonic exposure or superheated steam treatment. In particular, it is also known to treat surfaces with a jet of carbon dioxide particles.

These processes are also used in the production of plastic products for removing flash from a surface of the plastic products produced.

A combination of a number of the processes mentioned is often used to achieve the result that is respectively desired in the case of the applications described. However, the results are nevertheless often inadequate and not reproducible and the processes too laborious, with the result that they represent a limiting factor for product quality and also production speed.

In known processes in which carbon dioxide particles are used it is in particular the case that the particle size is not constant and not controllable, with the result that a uniform jet of particles cannot be achieved. In particular, there may be a pulsation of the jet of particles. Uniform cleaning or removal of flash or burr, in particular with a reproducible result, is not readily possible. Often, the process must be repeated a number of times, at least for individual regions of a surface to be treated. Situations in which the kinetic energy of the carbon dioxide particles is not sufficient are also known. In that case, a larger particle size would be desirable. Although it is attempted to achieve this in the prior art, known solutions with particularly large particles have the disadvantage that the particle size can vary greatly. Furthermore, known solutions with particularly large particles are often susceptible to faults, in particular in the case of an automated configuration.

### SUMMARY

On this basis, the object of the present invention here is to overcome at least partially the technical problems described in connection with the prior art. In particular, an arrangement for the treatment of a surface with which particularly uniform, particularly effective and particularly time-saving treatment of the surface is possible is intended to be presented. A corresponding process is also intended to be presented.

These objects are achieved by an arrangement and a process for treating a surface according to the features of the independent patent claims. Further advantageous refinements of the arrangement and of the process are provided in the respectively dependently formulated patent claims. The features set out individually in the patent claims can be combined with one another in any desired, technologically meaningful way and can be supplemented by explanatory substantive matter from the description, demonstrating further variants for the configuration of the invention.

According to the invention, an arrangement for treating a surface with a jet comprising a multiplicity of particles is presented. The arrangement comprises at least:
an outer nozzle, and
at least two inner nozzle units, which are enclosed by the outer nozzle and are designed to introduce in each case a stream of propellant gas mixed with a multiplicity of particles into the outer nozzle,
   the outer nozzle being designed to combine the streams of propellant gas of the inner nozzle units to form an overall stream of propellant gas.

The arrangement described is used for example in particular in the production of wire and plastic products, but can also be used in other applications, in particular in principle in the case of carbon dioxide jets. With the arrangement described, for example, cleaning the surface of a produced wire or a produced plastic product can be carried out. Flash or burr may also be removed from the surface of a produced wire or plastic product. Removing flash or burr means that excess material is removed from the surface. The excess material may be formed in particular as flash or burr at those places at which parts of a casting mould have been put together and/or at which an inlet for casting material into the casting mould is provided.

The particles are preferably formed from a substance that is liquid or gaseous at room temperature. In particular whenever the substance is gaseous at room temperature, the treatment of a surface can be carried out without residues of the substance remaining on the surface. The substance is preferably carbon dioxide. The particles may in particular take the form of snow, such as for example carbon dioxide snow.

The arrangement, and in particular the component parts of the arrangement that can come into contact with the substance and/or with the particles, is/are preferably formed with a material that can withstand low temperatures to be expected when that happens. In the case of solid carbon dioxide, the temperature may for example lie at approximately −80° C. Steel in particular, preferably high-grade steel, is preferred as the material for the arrangement.

In order to generate the jet comprising the multiplicity of particles, first the stream of propellant gas is provided in each of the inner nozzle units. This may be performed for example by a compressor. The stream of propellant gas is preferably a stream of compressed air. However, a gas other than air, such as for example nitrogen or carbon dioxide, may also be used.

The stream of propellant gas may for example be mixed with the particles in that the particles are formed from a solid starting material and are introduced into the stream of propellant gas or in that a liquid starting material is injected into the inner nozzle unit, whereby a snow can form in particular from the liquid starting material.

Once a respective stream of propellant gas has been mixed with particles in each of the inner nozzle units, all of the streams of propellant gas are preferably combined to form the overall stream of propellant gas. The overall stream of propellant gas is preferably formed by the individual streams of propellant gas of the inner nozzle units being mixed in the outer nozzle by swirling. It is in this case preferred that the overall stream of propellant gas is a uniform stream of gas. This means in particular that the overall stream of propellant gas is not stronger at the locations of the individual streams of propellant gas or at the locations of the individual inner nozzle units and weaker at locations between the individual streams of propellant gas or between the individual inner nozzle units. As a result, the overall stream of propellant gas can make uniform treatment of the surface possible.

Preferably, a plurality of inner nozzle units are arranged linearly. This allows an elongated, wide overall stream of propellant gas to be generated. Such a stream may be advantageous in particular in the treatment of large surfaces. In particular, with such a widened overall stream of propellant gas the time required for treating a surface can be reduced considerably. Preferably, distances between adjacent inner nozzle units are of the same size for all of the inner nozzle units.

It is alternatively preferred that a plurality of the inner nozzle units are arranged in a circular form. In this case, the inner nozzle units may be arranged on a circle or else on a number of circles, in particular concentrically arranged circles. A circular arrangement of the inner nozzle units allows an overall stream of propellant gas with a particularly large diameter to be achieved. Preferably, radial distances between adjacent inner nozzle units are of the same size for all of the inner nozzle units that are arranged on a common circle.

Preferably, the inner nozzle units are arranged in such a way that the streams of propellant gas generated in each case run parallel. It is also preferred that all of the inner nozzle units are configured identically. It is also preferred that each inner nozzle unit has an outlet for the respective stream of propellant gas, the outlets of all of the inner nozzle units lying in a plane.

In a preferred embodiment of the arrangement, the outer nozzle is configured as an outer Laval nozzle.

A Laval nozzle is especially suited for combining the individual inner streams of propellant gas uniformly.

In a further preferred embodiment of the arrangement, the outer nozzle has at least partly an oval cross section.

In particular in an outlet region of the outer nozzle, the cross section of the outer nozzle is preferably oval. An oval cross section of the outer nozzle allows an elongated overall stream of propellant gas to be generated. In the oval cross section, it is advantageously easily possible to arrange two or more inner nozzle units with a circular cross section linearly next to one another within the outer nozzle.

In a further preferred embodiment of the arrangement, at least one of the inner nozzle units comprises at least one inner Laval nozzle.

The inner Laval nozzle allows the stream of propellant gas of the respective inner nozzle unit to be mixed particularly uniformly with the particles.

In a further preferred embodiment of the arrangement, at least one of the inner nozzle units comprises at least one mixing chamber and an inner nozzle.

The mixing chamber is preferably designed to mix the stream of propellant gas with the multiplicity of particles. This should be understood as meaning that the mixing chamber is configured and connected to the particle generator in such a way that, after passing through the mixing chamber, the stream of propellant gas comprises the multiplicity of particles. The stream of propellant gas mixed with the multiplicity of particles in this way can be let out of the respective inner nozzle unit through the inner nozzle.

In a further preferred embodiment of the arrangement, an inlet into the mixing chamber has an inlet cross-sectional area that differs from a nozzle cross-sectional area of the inner nozzle.

It is preferred that at least one of the inner nozzle units and in particular all of the inner nozzle units comprises or comprise in each case at least:
a mixing chamber with an inlet for a stream of propellant gas, the mixing chamber being designed to mix the stream of propellant gas with the multiplicity of particles, and
an inner nozzle, which adjoins the mixing chamber and is connected to it in terms of flow and which has an outlet for the stream of propellant gas, a nozzle cross-sectional area of the inner nozzle as it progresses from the mixing chamber at first being reduced in size to a minimum nozzle cross-sectional area and then being increased in size again,
   the inlet having an inlet cross-sectional area, and an area quotient between the minimum nozzle cross-sectional area and the inlet cross-sectional area lying in the range from 15 to 300, preferably in the range from 25 to 225.

It has surprisingly been found by trials that the ratio between the inlet cross-sectional area and the minimum nozzle cross-sectional area, in particular the area quotient, has a particularly great influence on the thorough mixing of the stream of propellant gas with the particles. It has been found that the influence of the area quotient is in particular considerably greater than the influence of individual customarily varied parameters.

In a further preferred embodiment of the arrangement, at least one of the inner nozzle units comprises at least one particle generator.

It is preferred that at least one of the inner nozzle units and in particular all of the inner nozzle units comprises or comprise in each case at least:
a mixing chamber for mixing a stream of propellant gas with the multiplicity of particles,
a particle generator, which is designed to generate the multiplicity of particles and introduce them into the mixing chamber in a solid state, the particle generator having at least one screen plate, and it being possible for the multiplicity of particles to be formed in a solid state by pressing a solid starting material through the screen plate,
a propellant gas line with a propellant gas nozzle for introducing the propellant gas into the mixing chamber, and
an outlet from the mixing chamber for the stream of propellant gas.

The particle generator is preferably configured in such a way that the solid starting material can be pressed against the screen plate by way of a conveying screw or by way of a pneumatic or mechanical press. The generation of particles by means of the particle generator allows particularly large particles to be provided and mixed with the stream of propellant gas. The particles can thus be in particular larger than those that can be formed for example by atomization (expansion) of liquid carbon dioxide. Larger particles can have greater kinetic energy, and can therefore have a greater effect in the treatment of the surface. For example, with large particles, heavy soiling of a surface can be removed. The fact that the screen plate makes it possible to generate large particles of a uniform size means that a great and also uniform effect can be achieved with the arrangement described.

According to a further aspect of the invention, a process for treating a surface with a jet comprising a multiplicity of particles is presented, an arrangement as described being used.

The special advantages and design features of the arrangement that are described further above can be applied and transferred to the process described, and vice versa.

In a preferred embodiment of the process, the treating of the surface comprises at least one of the following steps:
cleaning the surface, and
removing flash or burr from the surface.
   The specified steps may be carried out alternatively or cumulatively, that is to say that a surface may just be cleaned, just have flash or burr removed or both be cleaned and have flash or burr removed,

### BRIEF DESCRIPTION OF THE DRAWINGS

The invention and the technical environment are explained in more detail below on the basis of the figures. The figures show particularly preferred exemplary embodiments, to which however the invention is not restricted. In particular, it should be pointed out that the figures, and in particular the relative sizes represented, are only schematic. In the figures:

FIG. 1 schematically shows a frontal sectional representation of an arrangement for treating a surface, and

FIG. 2 schematically shows a lateral sectional representation of an inner nozzle unit of the arrangement from FIG. 1.

### DESCRIPTION OF PREFERRED EMBODIMENTS

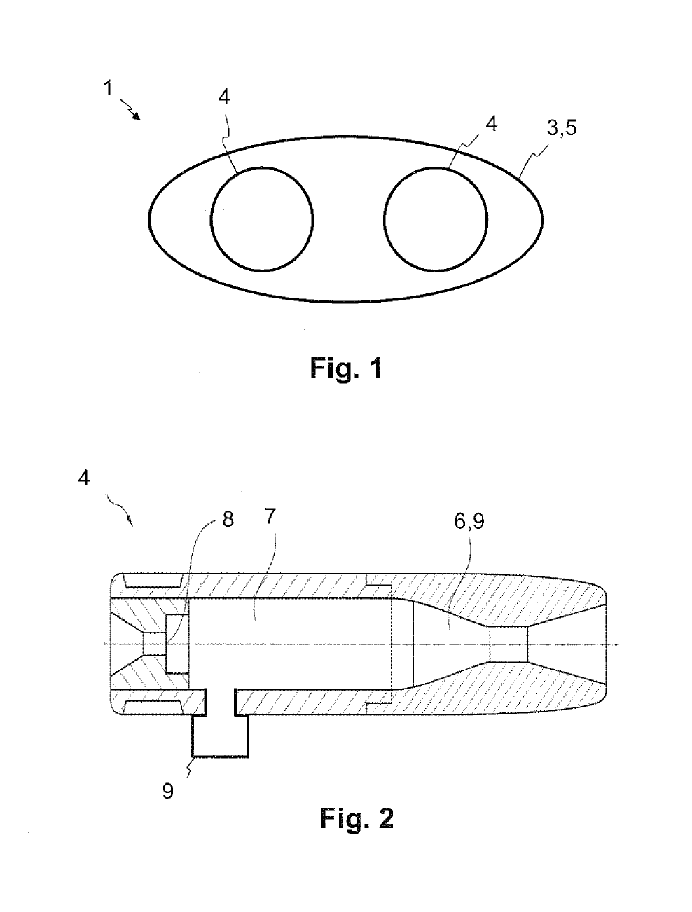

FIG. 1 shows a frontal sectional representation of an arrangement 1 for treating a surface with a jet comprising a multiplicity of particles. In this representation, the jet is oriented out of the plane of the drawing. The arrangement comprises an outer nozzle 3, configured as an outer Laval nozzle 5. The outer nozzle 3 has an oval cross section. The arrangement 1 also has two inner nozzle units 4, which are enclosed by the outer nozzle 3 and are designed to introduce in each case a stream of propellant gas mixed with a multiplicity of particles into the outer nozzle 3. The outer nozzle 3 is designed to combine the streams of propellant gas of the inner nozzle units 4 to form an overall stream of propellant gas.

FIG. 2 shows a lateral sectional representation of an example of an inner nozzle unit 4 of the arrangement 1 from FIG. 1. In this representation, the jet comprising a multiplicity of particles is oriented to the right-hand side. The inner nozzle unit 4 comprises a mixing chamber 2 with an inlet 7 for a stream of propellant gas. The mixing chamber 2 is designed to mix the stream of propellant gas with the multiplicity of particles. The inner nozzle unit 4 also comprises an inner nozzle 8, which is configured as an inner Laval nozzle 6, adjoins the mixing chamber 2 and is connected to it in terms of flow. A nozzle cross-sectional area of the inner Laval nozzle 6 as it progresses from the mixing chamber 2 is at first reduced in size to a minimum nozzle cross-sectional area and then increased in size again. The inlet 7 has an inlet cross-sectional area, an area quotient between the minimum nozzle cross-sectional area and the inlet cross-sectional area lying in the range from 15 to 300, preferably 25 to 225. In particular with regard to the area quotient, it should be pointed out that FIG. 2 is schematic and not to scale.

FIG. 2 also shows a particle generator 9, which is designed to generate the multiplicity of particles and introduce them into the mixing chamber 2 in a solid state.

With the arrangement presented and the process presented for treating a surface, a particularly uniform, particularly effective and particularly time-saving treatment of the surface can be achieved, for which purpose a particularly wide and uniform jet of particles can be used. This applies in particular to cleaning and removing flash or burr. The arrangement and the process may be used in particular in the production of wire or plastic products.

### LIST OF DESIGNATIONS

1 arrangement
2 mixing chamber
3 outer nozzle
4 inner nozzle unit
5 outer Laval nozzle
6 inner Laval nozzle
7 inlet
8 inner nozzle
9 particle generator

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-9. (canceled)

10. An apparatus for treating a surface with a jet comprising a multiplicity of particles, the apparatus comprising:
an outer nozzle, and
at least two inner nozzle units, enclosed by the outer nozzle and designed to introduce a stream of propellant gas mixed with a multiplicity of particles into the outer nozzle,
the outer nozzle configured to combine the streams of propellant gas of the inner nozzle units to form an overall stream of propellant gas.

11. The apparatus of claim 10, wherein the outer nozzle is configured as an outer Laval nozzle.

12. The apparatus of claim 10, wherein the outer nozzle has at least partly an oval cross section.

13. The apparatus of claim 10, wherein at least one of the inner nozzle units comprises at least one inner Laval nozzle.

14. The apparatus of claim 10, wherein at least one of the inner nozzle units comprises at least one mixing chamber and an inner nozzle.

15. The apparatus of claim 14, further comprising an inlet into the mixing chamber having an inlet cross-sectional area that differs from a nozzle cross-sectional area of the inner nozzle.

16. The apparatus of claim 10, wherein at least one of the inner nozzle units comprises at least one particle generator.

17. A process for treating a surface with a jet comprising a multiplicity of particles, utilizing the apparatus of claim 10.

18. The process of claim 17, wherein the treating of the surface comprises at least one of the following steps:
cleaning the surface, and
removing flash or burr from the surface.
